(19) United States
(12) Patent Application Publication
(10) Pub. No.: US 2009/0002267 A1
(43) Pub. Date: Jan. 1, 2009

(54) ELECTRONIC DISPLAY

(76) Inventors: Hui Nam, Yongin-si (KR); Beom-Shik Kim, Yongin-si (KR); Chan-Young Park, Yongin-si (KR); Ja-Seung Ku, Yongin-si (KR)

Correspondence Address: CHRISTIE, PARKER & HALE, LLP, PO BOX 7068, PASADENA, CA, 91109-7068, US

(21) Appl. No.: 12/114,320

(22) Filed: May 2, 2008

(30) Foreign Application Priority Data
Jun. 27, 2007 (KR) 10-2007-0063740

(51) Int. Cl. G09G 5/00

(52) U.S. Cl. 345/6; 345/4

(57) ABSTRACT

An electronic display includes a display unit for displaying both a two-dimensional image and a three-dimensional image, and a barrier facing the display unit to convert an image into the two-dimensional or three-dimensional image. The barrier includes first and second substrates facing each other, a plurality of first electrodes on the first substrate, an insulation layer on the first substrate and covering the first electrodes, a plurality of second electrodes on the insulation layer, and a liquid crystal layer disposed between the first and second substrates. The first electrodes are aligned with gaps between the second electrodes and the second electrodes are aligned with gaps between the first electrodes. Widths of the first electrodes may be equal to or greater than the gaps between the second electrodes. Widths of the second electrodes may be equal to or greater than the gaps between the first electrodes.

### CROSS-REFERENCE TO RELATED APPLICATION

This application claims priority to and the benefit of Korean Patent Application No. 10-2007-0063740 filed in the Korean Intellectual Property Office on Jun. 27, 2007, the entire content of which is incorporated herein by reference.

### BACKGROUND OF THE INVENTION

1. Field of the Invention

The present invention relates to electronic displays, and, more particularly, to an autostereoscopic electronic display using a barrier.

2. Description of the Related Art

In electronic displays, a stereoscopic device can provide different images to left and right eyes of a user so that the user can preceive distance and have a stereoscopic sense of an image. An autostereoscopic electronic display is configured to provide a stereoscopic image to the user even when the user does not use an instrument such as polarizing spectacles.

The conventional autostereoscopic electronic display employs a method for space-dividing an image displayed on an image display unit by providing, for example, a parallax barrier, a lenticular lens, or a micro-lens array on a front surface of the image display unit.

The parallax barrier may be formed in a liquid crystal shutter using technologies such as a transmissive type of liquid crystal display. In this case, a mode conversion between a two-dimensional (2D) image mode and a three-dimensional (3D) mode (stereoscopic image mode) becomes possible. As such, the parallax barrier can be effectively applied to a laptop computer or a mobile phone.

Generally, the parallax barrier includes light blocking portions arranged in a stripe pattern and light transmitting portions arranged in a stripe pattern. Therefore, a right eye image realized by right eye sub-pixels reaches the right eye of the user through the light transmitting portions of the parallax barrier and a left eye image realized by left eye sub-pixels reaches the left eye of the user through the light transmitting portions of the parallax barrier. Therefore, the user can perceive the image displayed on the image display unit as a stereoscopic image.

However, since the electronic display having the parallax barrier is designed to divide the image into the right and left eye images to display the 3D image, the resolution of the 3D image is reduced to half the resolution of the 2D image.

To solve this problem, a time-division driving type of electronic display has been developed. The time-division driving type of electronic display alternately displays the left and right eye images on the display unit at predetermined time intervals. In order to realize this, the parallax barrier forms light blocking portions and light transmitting portions such that patterns of the light blocking portions and light transmitting portions change with each other. By employing this time-division driving method instead of the space-division driving method, the electronic image display can display the 3D image with resolution that is not deteriorated.

### SUMMARY OF THE INVENTION

An exemplary embodiment of the present invention provides an electronic display that can display a stereoscopic image having high resolution using a parallax barrier.

In an exemplary embodiment of the present invention, an electronic display includes a display unit for displaying a 2D image and/or a 3D image, and a barrier that is disposed facing the display unit to convert an image into the 2D or 3D image. The barrier includes first and second substrates facing each other. A plurality of first electrodes is formed on the first substrate. An insulation layer is formed on the first substrate and covers the first electrodes. A plurality of second electrodes is formed on the insulation layer. A liquid crystal layer is disposed between the first and second substrates. The first electrodes are aligned with gaps between the second electrodes and the second electrodes are aligned with gaps between the first electrodes.

Widths of the first electrodes may be equal to or greater than the corresponding gaps between the second electrodes.

Widths of the second electrodes may be equal to or greater than the corresponding gaps between the first electrodes.

The first electrodes and the second electrodes may be arranged in stripe patterns, and the widths of the first electrodes may be substantially the same as those of the second electrodes.

The gaps between the first electrodes may be substantially the same as those between the second electrodes.

The widths of the first electrodes, the widths of the second electrodes, the gaps between the first electrodes, and the gaps between the second electrodes may be same as each other.

When the widths of the first electrodes are substantially the same as those of the second electrodes and the gaps between the first electrodes are substantially the same as those between the second electrodes, the widths may be greater than the gaps.

Both edges of each of the second electrodes in a width direction may overlap adjacent edges of the adjacent first electrodes.

The electronic display may further include a third electrode formed on the second substrate. The third substrate may be formed in a single body on the whole surface of the second substrate. The barrier may be a normally white mode liquid crystal display.

Further, the display unit may include first and second pixel groups that are alternately arranged in a direction in which the first electrodes are spaced apart from each other. A liquid crystal driving voltage may be applied to the first electrodes in a first period so that pixels of the first pixel groups display a left eye image and pixels of the second pixel groups display a right eye image. In addition, a liquid crystal driving voltage is applied to the second electrodes in a second period so that the pixels of the first pixel groups display the right eye image and the pixels of the second pixel groups display the left eye image. The left and right eye images are displayed through time-division driving.

The barrier may be turned off when the display unit displays a 2D image.

### BRIEF DESCRIPTION OF THE DRAWINGS

FIG. 1 is a schematic sectional view of an electronic display according to a first exemplary embodiment of the present invention.

FIG. 2A is a partial top plan view illustrating first electrodes formed on a first substrate of a barrier of FIG. 1.

FIG. 2B is a partial top plan view illustrating second electrodes formed on a first substrate of a barrier of FIG. 1.

FIG. 3 is a partial top plan view illustrating a relationship between first and second electrodes formed on a first substrate of a barrier of FIG. 1.

FIG. 4A is a view illustrating a pixel arrangement of a display unit of FIG. 1 in a first period t₁.

FIG. 4B is a view illustrating a pixel arrangement of a display unit of FIG. 1 in a second period t₂.

FIG. 5 is a schematic sectional view of an electronic display according to another exemplary embodiment of the present invention.

### DETAILED DESCRIPTION OF THE EMBODIMENTS

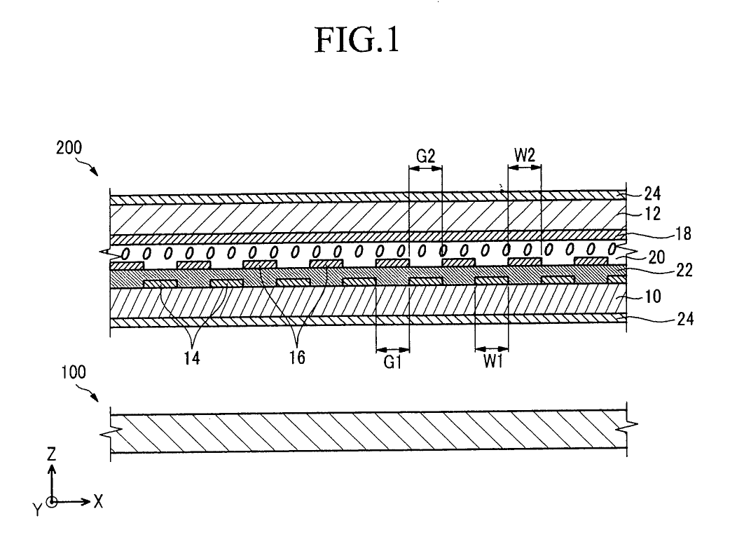

Referring to FIG. 1, an electronic display of an exemplary embodiment of the present invention includes a display unit 100 and a barrier 200.

The display unit 100 displays right and left eye images each having a predetermined pattern. In this case, the patterns of the left and right eye images can be realized by first and second images that are alternately displayed with a predetermined image frequency.

Any display device may be used as the display unit 100. For example, the display unit 100 may be one of a cathode ray tube (CRT), a liquid crystal display (LCD), a plasma display panel (PDP), a field emission display (FED), and an organic light emitting display (OLED).

The barrier 200 may be formed of a normally white mode LCD that transmits light in an off-state and blocks the light in an on-state.

In more detail, the barrier 200 includes first and second substrates 10, 12, a plurality of first electrodes 14, a plurality of second electrodes 16, a third electrode 18, and a liquid crystal layer 20.

The first and second substrates 10, 12 face each other with a predetermined interval therebetween. Each of the first and second substrates 10, 12 is formed of a rectangular glass plate having a pair of short-sides and a pair of long-sides.

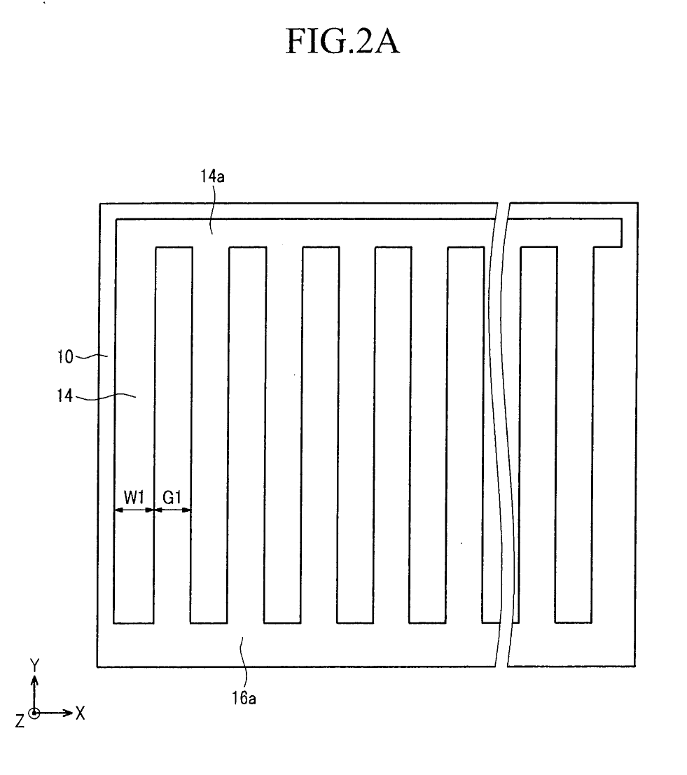

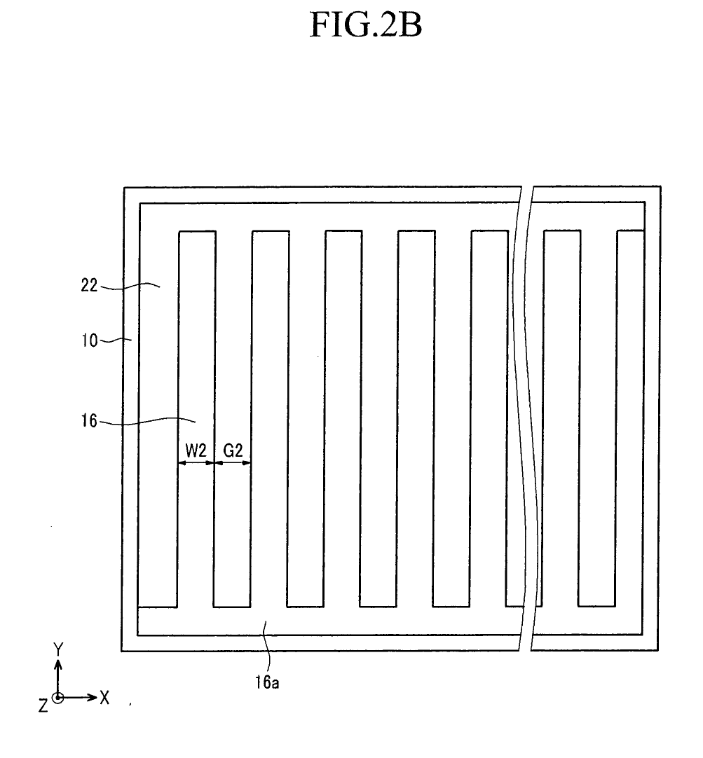

FIG. 2A is a partial top plan view illustrating the first electrodes formed on the first substrate of the barrier of FIG. 1, and FIG. 2B is a partial top plan view illustrating the second electrodes formed on the first substrate of the barrier of FIG. 1.

Referring to FIG. 2A, the first electrodes 14 are formed on an inner surface of the first substrate 10. The first electrodes 14 are spaced apart from each other. The first electrodes 14 are formed extending in a first direction (a Y-direction in FIG. 2A) that is in parallel with the short sides of the first substrate 10. That is, the first electrodes 14 are arranged in a stripe pattern and spaced apart from each other by a predetermined gap G1.

In addition, as shown in FIG. 2A, a first connecting electrode 14a for electrically interconnecting the first electrodes 14 is formed on the first substrate 10. The first connecting electrode 14a extends in a second direction (an X-direction in FIG. 2A), which is in parallel with the long-sides of the first substrate 10, at first ends of the first electrodes 14.

Referring to FIG. 2B, an insulation layer 22 is formed on the first substrate 10 while covering the first electrodes 14 and the first connecting electrode 14a. The insulation layer 22 may be formed of a transparent material such as SiO₂.

The second electrodes 16 are formed on the insulation layer 22 and arranged in a stripe pattern extending in the first direction (the Y-direction). That is, the second electrodes 16 are spaced apart from each other by a predetermined gap G2. Further, as shown in FIG. 2B, a second connecting electrode 16a electrically interconnecting the second electrodes 16 is formed on the insulation layer 22. The second connecting electrode 16a extends in the second direction (the X-direction in FIG. 2B) at first ends of the first electrodes 14. The second electrodes 16 and the second connecting electrode 16a are insulated from the first electrodes 14 and the first connecting electrode 14a by the insulation layer 22.

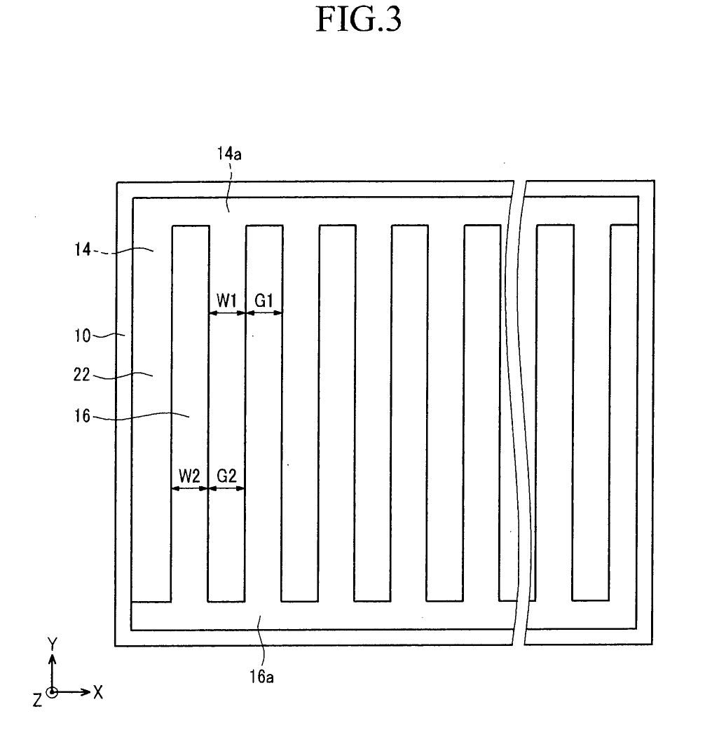

FIG. 3 is a partial top plan view illustrating a relationship of the first and second electrodes formed on the barrier.

Referring to FIG. 3, each of the first electrodes 14 has a predetermined width W1 and each of the second electrodes 16 has a predetermined width W2. The first and second electrodes 14, 16 are alternately arranged in the second direction (the X-direction). The widths W1, W2 may be substantially the same as each other. Further, in the present exemplary embodiment, the second electrodes 16 are disposed between the first electrodes 14 over the gap G1 between the first electrodes 14. The first electrodes 14 are disposed between the second electrodes 16 under the gap G2 between the second electrodes 16.

That is, the widths W1, W2 are substantially the same as each other and the gaps G1, G2 are also substantially the same as each other. As shown in FIG. 3, the edges of the first electrodes 14 coincide with the edges of the second electrodes 15 on an X-Y plane.

The third electrode 18 is formed on an inner surface of the second substrate 12. The third electrode 18 may be provided as a single body or may be divided into a plurality of line sections extending in a direction intersecting the first and second electrodes 14, 16. The first, second, and third electrodes 14, 16, 18 may be formed of a transparent material such as indium tin oxide (ITO).

In addition, orientation layers (not shown) are formed above the second and third electrodes 16, 18. The liquid crystal layer 20 is formed between the orientation layers. Further, polarizing plates 24 are respectively disposed on outer surfaces of the first and second substrates 10, 12.

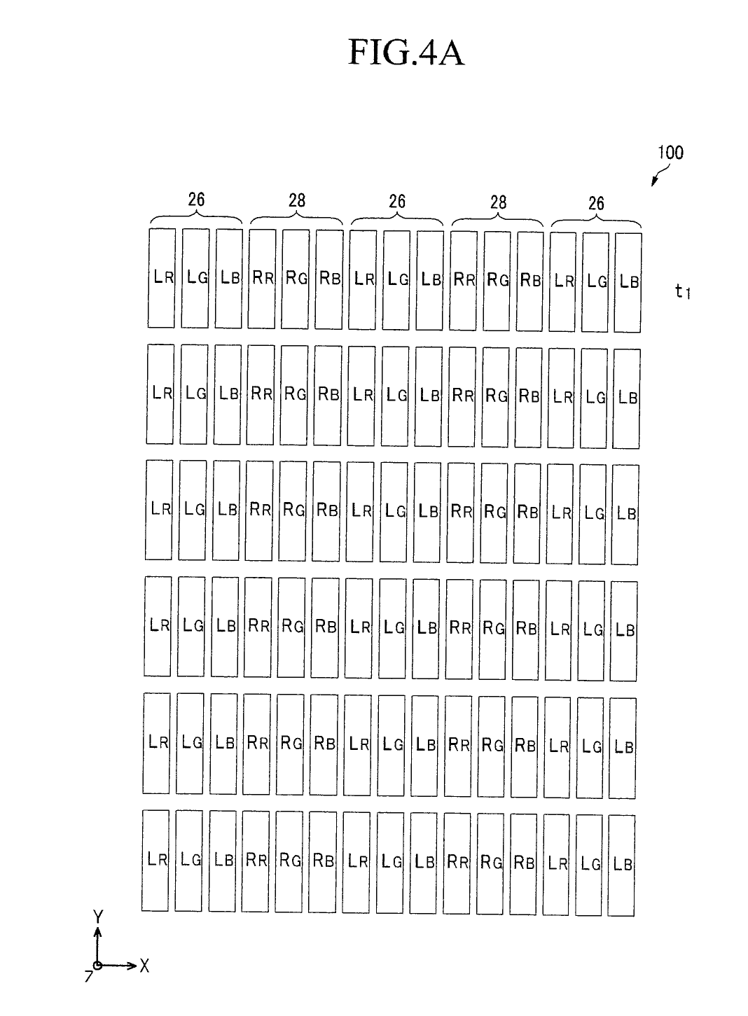

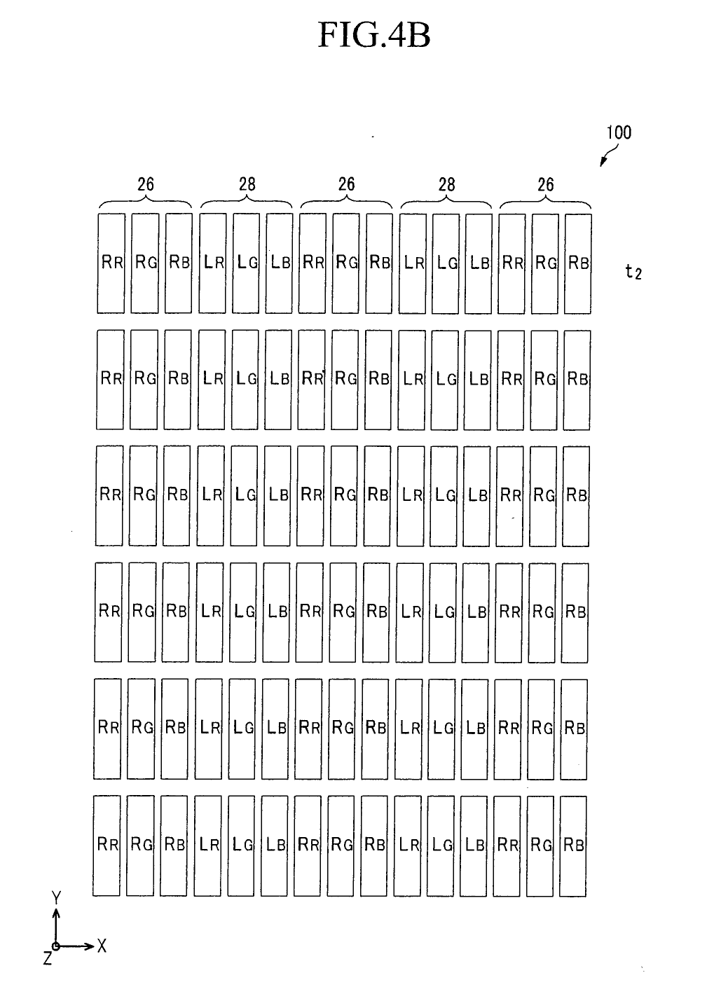

The following will describe a pixel arrangement and operation of the display unit 100. FIGS. 4A and 4B show pixel arrangements of the display unit for first and second periods t₁, t₂, respectively. The display unit 100 includes first pixel groups and second pixel groups that are alternately arranged in the first direction. Identical color pixels in the first and second pixel groups 26, 28 are arranged in the second (X) direction.

As shown in FIG. 4A, in the first period t₁, pixels L_{R}, L_{G}, L_{B} of the first pixel groups 26 display a left eye image in response to a left eye video signal, and pixels R_{R}, R_{G}, R_{B} of the second pixel groups 28 display a right eye image in response to a right eye video signal. As described above, in the first period t₁, a first image is displayed on the display unit.

In the first period t₁ in which the display unit 100 displays the first image, a liquid crystal driving voltage is applied to the first electrodes 14 through the first connecting electrode 14a and a reference voltage (e.g., a ground voltage) is applied to the second electrodes 16 through the second connecting electrode 16a. In addition, a reference voltage is applied to the third electrode 18. At this point, the first electrodes 14 function as light blocking portions and the second electrodes 16 function as light transmitting portions.

As shown in FIG. 4B, unlike the first period t₁, in the second period t₂, the pixels R_{R}, R_{G}, R_{B} of the first pixel groups 26 display a right eye image in response to the right eye video signal, and the pixels L_{R}, L_{G}, L_{B} of the second pixel groups 28 display a left eye image in response to a left eye video signal. As described above, in the second period t₂, a second image is displayed on the display unit.

In the second period t₂ in which the display unit 100 displays the second image, the liquid crystal driving voltage is applied to the second electrodes 16 through the second connecting electrode 16a and the reference voltage is applied to the first electrodes 14 through the first connecting electrode 14a. In addition, a reference voltage is applied to the third electrode 18. At this point, the first electrodes 14 function as the light transmitting portions and the second electrodes 16 function as the light blocking portions.

By driving the display unit 100 and the barrier 200 as described above, the left eye of the user receives the image realized by the pixels of the first pixel groups 26 during the first period t₁ and receives the image realized by the pixels of the second pixel groups 28 during the second period t₂. In addition, the right eye of the user receives the image realized by the pixels of the second pixel groups 28 during the first period t₁ and receives the image realized by the pixels of the first pixel groups 26 during the second period t₂. Therefore, since the stereoscopic image is realized through time-division rather than through space-division, the resolution of the stereoscopic image becomes substantially the same as that of the 2D image.

In the present exemplary embodiment, no gap is formed between the adjacent first and second electrodes 14, 16 of the barrier 200. Therefore, light leakage between the first and second electrodes 14, 16 is minimized.

As a result, in the electronic display of the present exemplary embodiment, the deterioration of the 3D image, which is caused by crosstalk, can be prevented.

Further, if required, the electronic display of the present exemplary embodiment can realize the 2D image mode by turning off the barrier and inputting a 2D video signal to the pixels of the first and second pixel groups of the display unit.

The following will describe an electronic display according to another exemplary embodiment of the present invention.

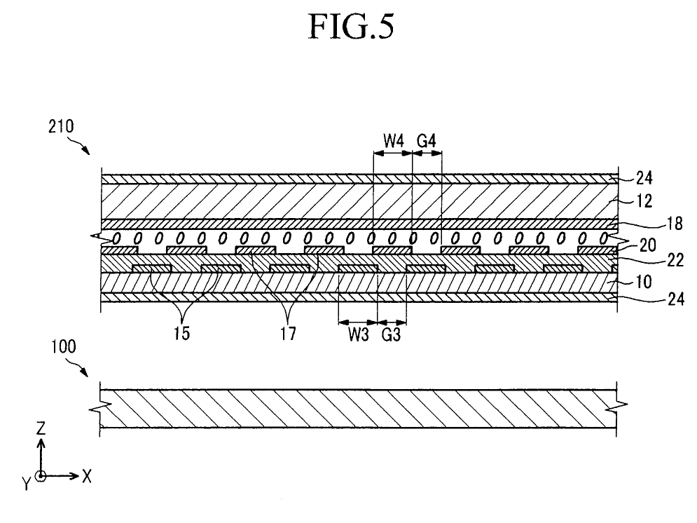

FIG. 5 is a sectional view of an electronic display according to another exemplary embodiment of the present invention. An electronic display of this exemplary embodiment is somewhat similar to that of the foregoing embodiment of FIG. 1. Therefore, in the following description, like parts of the exemplary embodiments will be assigned with like reference numerals and a description thereof will be omitted.

As shown in FIG. 5, in barrier 210 first electrodes 15 are disposed on a first substrate 10 and arranged in a stripe pattern extending in a first (Y) direction. A gap G3 between the adjacent first electrodes 15 is less than a width of each of the first electrodes 15. In addition, second electrodes 17 are disposed on an insulation layer 22 and extend in the first direction. A gap G4 between the adjacent second electrodes 17 is less than a width W4 of each of the second electrodes 17. The widths W3, W4 may be substantially the same as each other. The gaps G3, G4 may also be substantially the same as each other.

Under this condition, when the first and second electrodes 15, 17 are alternately arranged in a second (X) direction, both edges of each of the second electrodes 17 overlap the first electrodes 15.

As such, the second electrodes 17 are disposed above the first electrodes 15 while overlapping the first electrodes 15 as well as the gaps G3 between the first electrodes 15. A width of each of the overlapping region between the first electrodes 15 and the second electrodes 17 is uniformly maintained.

In the operation of the electronic display of this exemplary embodiment, the light transmitting portions of the barrier 210 are defined by the gaps G3 between the first electrodes or the gaps G4 of the second electrodes, and the light blocking portions are defined by the first electrodes 15 or the second electrodes 17.

Since a width of the light transmitting portion is less than that of the light blocking portion due to the arrangement of the first and second electrodes 15, 17, light leakage between the first and second electrodes 15, 17 during the operation of the barrier 210 can be prevented.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An electronic display comprising:
a display unit for displaying an image; and
a barrier facing the display unit for converting the image into a two-dimensional image or a three-dimensional image,
wherein the barrier includes:
a first substrate and a second substrate facing each other,
a plurality of first electrodes on the first substrate, an insulation layer on the first substrate and covering the first electrodes,
a plurality of second electrodes on the insulation layer, and
a liquid crystal layer between the first and second substrates,
wherein the first electrodes are aligned with gaps between the second electrodes and the second electrodes are aligned with gaps between the first electrodes, and widths of the first electrodes are equal to or greater than the gaps between the second electrodes.

2. The electronic display of claim 1, wherein the first electrodes and the second electrodes are in stripe patterns.

3. The electronic display of claim 1, wherein the widths of the first electrodes are substantially the same as the widths of the second electrodes.

4. The electronic display of claim 1, wherein the gaps between the first electrodes are substantially the same as the gaps between the second electrodes.

5. The electronic display of claim 1, wherein the widths of the first electrodes, the widths of the second electrodes, the gaps between the first electrodes, and the gaps between the second electrodes are substantially the same as each other.

6. The electronic display of claim 1, wherein the widths of the first electrodes are same as those of the second electrodes and the gaps between the first electrodes are same as those between the second electrodes, the widths are greater than the gaps.

7. The electronic display of claim 1, wherein both edges of each of the second electrodes in a width direction overlap adjacent edges of adjacent first electrodes.

8. The electronic display of claim 1, further comprising a third electrode on the second substrate, wherein the third electrode is a single body on the second substrate.

9. The electronic display of claim 1, wherein the barrier is a normally white mode liquid crystal display.

10. The electronic display of claim 1, wherein the display unit includes first pixel groups and second pixel groups alternately arranged in a direction in which the first electrodes are spaced apart from each other;
a liquid crystal driving voltage is applied to the first electrodes in a first period such that pixels of the first pixel groups display a left eye image and pixels of the second pixel groups display a right eye image; and
a liquid crystal driving voltage is applied to the second electrodes in a second period such that the pixels of the first pixel groups display the right eye image and the pixels of the second pixel groups display the left eye image.

11. The electronic display of claim 9, wherein the left eye image and the right eye image are displayed using time-division driving.

12. The electronic display of claim 1, wherein, when the display unit displays the two-dimensional image, the barrier is turned off.

13. An electronic display comprising:
a display unit for displaying an two-dimensional image; and
a barrier facing the display unit for converting the image into a two-dimensional image or a three-dimensional image,
wherein the barrier includes:
a first substrate and a second substrate facing each other,
a plurality of first electrodes on the first substrate, an insulation layer on the first substrate and covering the first electrodes,
a plurality of second electrodes on the insulation layer, and
a liquid crystal layer between the first and second substrates,
wherein the first electrodes are aligned with gaps between the second electrodes and the second electrodes are aligned with gaps between the first electrodes, and widths of the second electrodes are equal to or greater than the gaps between the first electrodes.

14. The electronic display of claim 13, wherein the first electrodes and the second electrodes are in stripe patterns.

15. The electronic display of claim 13, wherein the widths of the first electrodes are substantially the same as the widths of the second electrodes.

16. The electronic display of claim 13, wherein the gaps between the first electrodes are substantially the same as the gaps between the second electrodes.

17. The electronic display of claim 13, wherein both edges of each of the second electrodes in a width direction overlap adjacent edges of adjacent first electrodes.

18. The electronic display of claim 13, further comprising a third electrode on the second substrate, wherein the third electrode is a single body on the second substrate.

19. The electronic display of claim 13, wherein the barrier is a normally white mode liquid crystal display.

20. The electronic display of claim 13, wherein the display unit includes first pixel groups and second pixel groups alternately arranged in a direction in which the first electrodes are spaced apart from each other;
a liquid crystal driving voltage is applied to the first electrodes in a first period such that pixels of the first pixel groups display a left eye image and pixels of the second pixel groups display a right eye image; and
a liquid crystal driving voltage is applied to the second electrodes in a second period such that the pixels of the first pixel groups display the right eye image and the pixels of the second pixel groups display the left eye image.

21. The electronic display of claim 20, wherein the left eye image and the right eye image are displayed using time-division driving.

22. The electronic display of claim 13, wherein the barrier is turned off when the display unit displays the two-dimensional image.
